(19) United States
(12) Patent Application Publication
(10) Pub. No.: US 2011/0055929 A1
(43) Pub. Date: Mar. 3, 2011

(54) METHOD FOR PRODUCING AN IMAGE INTENDED FOR AN OPERATING SYSTEM CALLED OS IMAGE AND CORRESPONDING DEVICE

(75) Inventors: Laurent Bardet, Ville (FR); Benoit Renard, Marcheprime (FR)

(73) Assignee: THALES, Neuilly Sur Seine (FR)

(21) Appl. No.: 12/873,066

(22) Filed: Aug. 31, 2010

(30) Foreign Application Priority Data
Sep. 1, 2009 (FR) 0904142

(51) Int. Cl. G06F 21/22

(52) U.S. Cl. 726/26

(57) ABSTRACT

A method for producing a standard OS image, intended for an operating system, including a compilation of at least one source file into at least one executable file. The method also including forming (form) an intermediate standard OS image (IM0) from the executable file(s), coding (cdg) the intermediate standard OS image so as to obtain a coded data sequence (BNC), and masking the coded data sequence (BNC) in a standard OS image (IM1).

### CROSS-REFERENCE TO PRIOR APPLICATIONS

The application claims priority to French Patent Application No. 09041412, filed on Sep. 1, 2009, which is incorporated by reference herein in its entirety.

### FIELD OF THE INVENTION

The invention relates to operating systems (OS), and more particularly to the images used by these systems, called standard OS images.

### BACKGROUND OF THE INVENTION

Standard OS images are data structures, which can be loaded by the operating system. These data structures contain objects necessary to the execution by the operating system of the applications linked to the operating system. It will be recalled that an application is a function implemented by software. These objects may be, for example, data files or else executable files, that is to say applications compiled in a form that can be directly executed by the operating system of the platform concerned.

A platform is a part of the embedded system including hardware resources and an operating system. It is intended to receive one or more applications which can be executed by its operating system. As for the hardware resources, they usually contain computation cards, input/output peripheral devices interconnected by networks, etc. Moreover, the platform is controlled by system software that is also called basic software. The system software conventionally contains the software for booting up the embedded system, and the standard OS image associated with the operating system concerned.

A platform user, before being able to launch the execution of a received application, extracts the executable files contained in the standard OS image, so that the operating system can use its content. This extraction is conventionally done upon powering up the system that incorporates the platform.

The production of the standard OS image can be done in a number of ways.

A simple production of a standard OS image includes a first step for compiling source files into executable files. Then, the standard OS image is created from the executable file, for example by adding a header chosen from the executable file data.

A more complex production of a standard image includes a step for coding the data of the executable file(s) (for example, a data encryption). The OS image(s) is/are then created from the coded executable file(s). One or more coded OS images are therefore obtained. In this particular case, the extraction of the executable files by the user therefore also entails decoding the data, in order to obtain the executable file or files.

One aim of the coding is to make it more difficult to analyse the content of an application by a possible hacker. The latter, in order to determine the content of an application, proceeds to analyse the coded OS image. However, the fact that a file needs a decoding in order to be executed reveals a singularity that can be exploited by the hacker, because of the simplifying of the identification of the data corresponding to the executable file.

Based on this identification, the hacker can easily determine the decoding method, which greatly reduces the data security level.

### SUMMARY OF THE INVENTION

An aspect of the invention increases the difficulty in identifying an application from the OS image that is created.

According to a first aspect of the invention, there is proposed a method for producing an image called standard OS image, intended for an operating system, including at least one compilation of at least one source file into at least one executable file.

According to an aspect, the method also includes:
a formation of an intermediate standard OS image from the executable file(s),
a coding of the intermediate standard OS image so as to obtain a coded data sequence,
a masking of the coded data sequence in a standard OS image.

In other words, the data is processed to give the coded data sequence the appearance of a standard OS image in order to mask:
the fact that data has been coded, and
the location of that data.

The security of the method for producing an OS image is thus enhanced.

Neither the executable file data nor the data from the coded data sequence is modified.

Further, it is inexpensive.

Further, the data transmitted to the user is not visibly coded. The notion of decoding appears only when executing the standard OS image.

Further, the standard OS image can be associated with a standard operating system, for example available on the market.

Further, the coding that is done is independent of the run-time environment, that is to say, of the system in which it may be incorporated.

According to one embodiment, the method may further include an association with the coded data sequence of data containing information concerning the decoding application.

According to one embodiment, the information concerning the decoding application may correspond to the decoding application itself.

This has the advantage of making the method independent when invoking an external decoding means.

According to one embodiment, the coding and transformation steps can be iterated at least twice.

This has the advantage of reinforcing the data masking security level.

According to another aspect, there is proposed a method for executing a standard OS image produced according to at least one of the characteristics stated above.

This execution method may include:
a first edit of the standard OS image so as to recover the coded data sequence,
a call to a decoding application so as to retrieve the intermediate standard OS image,
a second edit of the intermediate standard OS image so as to obtain the executable file.

According to one embodiment of the execution method, the first edit may also be used to recover the decoding application, which is used to retrieve the intermediate standard image.

According to another aspect, there is proposed a device for producing an image intended for an operating system called standard OS image.

According to an aspect, the device is capable of implementing a production method as mentioned above.

Preferably, the production method may be implemented by software.

According to another aspect, there is proposed a use of a device as described above, when implementing a secure platform.

### BRIEF DESCRIPTION OF THE DRAWINGS

Other advantages and features of the invention will become apparent from studying the detailed description of a method of implementing and using a device according to the invention, which are in no way limiting, and the appended drawings in which:

FIG. 1 relates to a method of using a device according to an embodiment of the invention, and

FIG. 2 illustrates an embodiment of a method for producing a standard OS image according to an embodiment of the invention,

FIG. 3 illustrates an embodiment of a method for executing a standard OS image according to an embodiment of the invention.

### DETAILED DESCRIPTION

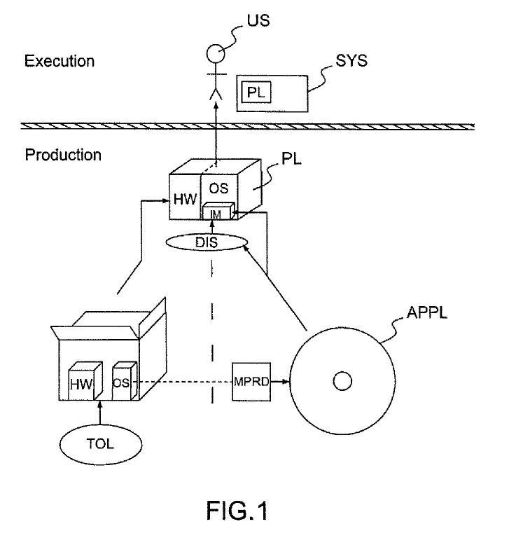

Reference is made to FIG. 1. This illustrates in a very diagrammatic way, a usage mode for a device DIS for producing an image intended for an operating system called standard OS image as opposed to a coded OS image.

The production of such a standard OS image is in this case incorporated in a production of a platform, in particular a secure platform PL. The latter is intended to be embedded on board a system SYS, for example a radar.

The production of the secure platform PL implements various objects.

First, TOL tools known to those skilled in the art are used to develop hardware resources HW and an operating system OS. The operating system OS may simply be a market-standard operating system.

At the same time, production means MPRD are used to produce applications APPL. The latter are implemented according to the abovementioned standard operating system OS.

The secure platform PL is then mounted using hardware resources HW, the standard operating system OS and standard images IM. The latter contain the executable files for the applications APPL. The standard images IM are generated using the device DIS according to certain applications produced previously. The production of the standard OS images will be described in more detail below.

Once embedded in the system SYS (for example a radar), the secure platform PL is then delivered to a user US. The latter can execute the various applications APPL, in particular the standard OS image which can be used to execute the standard operating system OS.

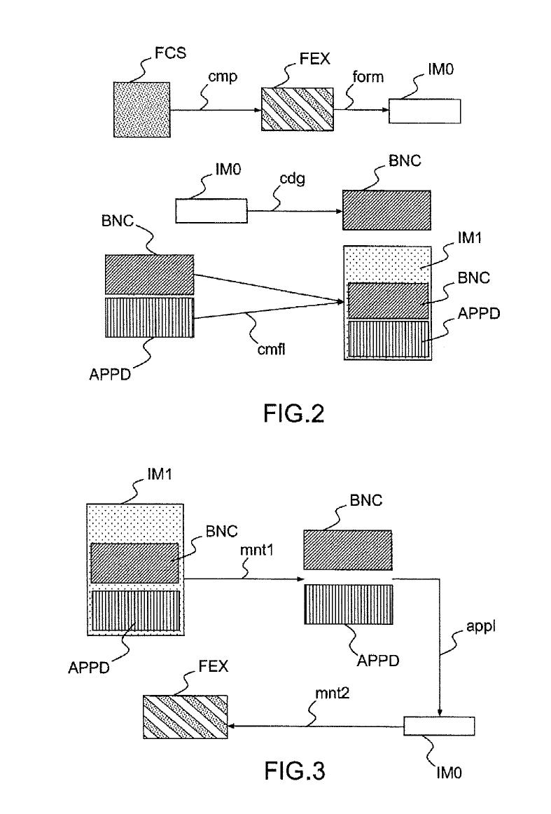

Reference is now made to FIG. 2, which illustrates an embodiment of a method for producing a standard OS image according to the invention.

First, a source file FCS is compiled cmp (in the interests of simplicity, only a single compilation of a single source file will be considered, but this example is obviously absolutely not limiting).

An executable file FEX is then obtained (similarly, in the interests of simplicity, only a single executable file is considered). There follows a formation step form for the formation of an intermediate standard OS image referenced IM0.

This intermediate standard OS image IM0 is then coded cdg. A file BNC, called coded binary by those skilled in the art, is then obtained. This file is a sequence of bytes that has a structure different from that of a standard OS image.

An information item APPD linked to the decoding application is then associated with this coded binary BNC, making it possible to reverse the coding done in the preceding step. For example, this information item APPD may be the decoding application itself. As a variant, this information item may correspond to a few data bytes making it possible to address a decoding application stored, for example, in a memory of the secure platform.

According to another variant, the decoding of the data may be applied independently. In this case, the next step is applied only to the coded binary BNC.

Finally, a masking cmfl is then applied to the coded binary/decoding application BNC/APPD pairing so as to form a standard OS image IM1, which can be directly interpreted by an operating system. In other words, the masking includes a rearrangement of the data of the coded binary BNC and of the decoding application APPD, so that they have the structure of a standard OS image. This rearrangement may for example entail adding a header.

The production of the standard OS image is in this case done in order to conceal the coded data. A possible hacker is thus prevented from finding out that the data has been coded, and consequently from locating the application among all the data.

It will be noted that, in order to reinforce the masking, it is possible to reiterate the coding and masking steps. In other words, the standard OS image IM1 is coded so as to obtain a new coded binary that is associated with the decoding application corresponding to the coding method used.

Then, the coding operation is reiterated on the new coded binary/decoding application combination, and so on.

Reference is now made to FIG. 3 which illustrates an embodiment of a method for executing a standard OS image so as to recover the executable file FEX, the standard OS image having been produced according to one embodiment of a production method of the invention.

In the embodiment illustrated in FIG. 3, it is considered, unless otherwise indicated, that the standard OS image IM1 directly incorporates the decoding application APPD.

A first edit mnt1 is used to extract the coded binary BNC and the decoding application APPD. The decoding application APPD is then called appl in order to decode the coded binary BNC.

On completion of the decoding of the coded binary, the intermediate standard OS image IM0 is retrieved. A second edit of this intermediate standard OS image IM0 can then be carried out in order to retrieve the executable file FEX.

The present invention is not limited to the embodiments described herein, reference should be had to the appended claims.

1. A method for producing a standard OS image, intended for an operating system, comprising at least one compilation of at least one source file into at least one executable file, the method comprising the following steps:
forming an intermediate standard OS image (IM0) from said at least one executable file,
coding (cdg) said intermediate standard OS image so as to obtain a coded data sequence (BNC),
masking the coded data sequence (BNC) in a standard OS image (IM1).

2. The method according to claim 1, further comprising associating the coded data sequence (BNC) with data containing information concerning the decoding application (APPD).

3. The method according to claim 2, wherein the information concerning the decoding application (APPD) corresponds to the decoding application itself.

4. The method according to claim 1, wherein the coding and transformation steps are iterated at least twice.

5. A method for executing a standard OS image produced by forming an intermediate standard OS image (IM0) from said at least one executable file, coding (cdg) said intermediate standard OS image so as to obtain a coded data sequence (BNC), and masking the coded data sequence (BNC) in a standard OS image (IM1), the method comprising the following steps:
editing the standard OS image so as to recover said coded data sequence,
calling decoding application so as to retrieve the intermediate standard OS image,
editing the intermediate standard OS image so as to obtain said executable file.

6. The method according to claim 1, wherein the information concerning the decoding application (APPD) corresponds to the decoding application itself, and wherein the step of editing the standard OS image so as to recover said coded data sequence is also used to recover said decoding application, which is used to retrieve the intermediate standard image.

7. A device (DIS) for producing an image intended for a standard OS image operating system, comprising a programmed processor and a memory with instructions which cause the processor to:
form an intermediate standard OS image (IM0) from said at least one executable file;
code (cdg) said intermediate standard OS image so as to obtain a coded data sequence (BNC); and
mask the coded data sequence (BNC) in a standard OS image (IM1).

8. The device (DIS) according to claim 7, wherein the instructions are implemented by software.

9. The device of claim 8, wherein the device is used to implement a secure platform (PL).
